(19) United States
(12) Patent Application Publication
(10) Pub. No.: US 2008/0257831 A1
(43) Pub. Date: Oct. 23, 2008

(54) Water Treating Agent and Water Treatment Method

(76) Inventors: Junichi Nakajima, Ehime-ken (JP); Takanari Kume, Ehime-ken (JP); Yasuo Nogami, Ehime-ken (JP); Isamu Mekata, Ehime-ken (JP)

Correspondence Address: BIRCH STEWART KOLASCH & BIRCH, PO BOX 747, FALLS CHURCH, VA, 22040-0747, US

(21) Appl. No.: 11/885,150

(22) PCT Filed: Mar. 20, 2006
(86) PCT No.: PCT/JP06/06064

§ 371 Date: Aug. 27, 2007

(30) Foreign Application Priority Data
Mar. 30, 2005 (JP) 2005-099551

(51) Int. Cl. C02F 1/68; C09D 5/08

(52) U.S. Cl. 210/749; 106/14.11; 106/14.21; 106/14.18

(57) ABSTRACT

A water treating agent is constituted by blending water as a main component with a coating film forming agent of which a coating film is formed on the heat transfer surface of a boiler tube, a oxygen scavenger, a scale inhibitor, and a pH adjustor in such a manner that the general corrosion and local corrosion of the heat transfer surface of the boiler tube can be prevented and excellent heat transfer property can be obtained. The water treating agent is injected into boiler feed water to perform the prevention of the corrosion of the heat transfer surface of the boiler tube and the suppression of the scaling of the heat transfer surface in a balanced manner. Thus, a coating film capable of suppressing corrosion is formed of the coating film forming agent on the heat transfer surface of the boiler tube. Dissolved oxygen in boiler feed water is removed by the oxygen scavenger. Furthermore, the scaling of the heat transfer surface of the boiler tube is prevented by the scale inhibitor, and the pH of the boiler feed water is adjusted. Therefore, the general corrosion and local corrosion of the heat transfer surface of the boiler tube can be prevented, and excellent heat transfer property can be obtained.

### BACKGROUND OF THE INVENTION

1. Field of the Invention

The present invention relates to a water treating agent and a water treatment method. More specifically, the present invention relates to a water treating agent capable of preventing the general corrosion and local corrosion of the heat transfer surface of a boiler tube and of providing excellent heat transfer property, and a water treatment method using the water treating agent.

2. Description of the Related Art

A boiler, which is widely used as an energy supply facility for heating, power generation, or the like, is a device that generates steam. The inner surface portion of a water pipe for generating steam in a boiler (the heat transfer surface of a boiler tube) is in a high-temperature, high-pressure environment. A component such as calcium in water (boiler feed water) supplied to the boiler adheres as a scale to the heat transfer surface (scaling), or the heat transfer surfaces is corroded by the boiler feed water.

When a scale adheres to the heat transfer surface, the scale prevents heat transfer, with the result that heat transfer property such as boiler efficiency reduces. In addition, when the heat transfer surface is corroded, the corrosion damages the boiler tube. The operation of the boiler may be stopped depending on the degree of the damage to the boiler tube.

In view of the foregoing, a chemical such as a scale inhibitor or a pH adjustor has been conventionally added as a water treating agent to boiler feed water in order to prevent (suppress) the scaling or corrosion of the heat transfer surface of a boiler tube. However, conventional water treating agents have been used individually for preventing the scaling of the heat transfer surface of a boiler tube and preventing the corrosion of the heat transfer surface, so it has been difficult to perform the prevention of the scaling of the heat transfer surface of the boiler tube and the prevention of the corrosion of the heat transfer surface simultaneously in a balanced manner.

That is, the addition of a water treating agent to boiler feed water for the purpose of preventing the scaling of the heat transfer surface of a water pipe has been unable to sufficiently prevent the corrosion of the heat transfer surface although the addition has been able to prevent the scaling of the heat transfer surface. On the other hand, the addition of a water treating agent to the boiler feed water for the purpose of preventing the corrosion of the heat transfer surface has been unable to sufficiently prevent the scaling of the heat transfer surface although the addition has been able to prevent the corrosion of the heat transfer surface.

In view of the foregoing, there has been proposed a water treating agent containing silica, a pH adjustor, and a scale inhibitor as a water treating agent capable of performing the prevention of the scaling of a heat transfer surface and the prevention of the corrosion of the heat transfer surface simultaneously in a balanced manner in order to suppress the corrosion of a heat transfer surface and the generation of a scale caused by an influence of water (see JP 2003-159597 A).

The water treating agent described in JP 2003-159597 A forms a silica layer and an iron hydroxide layer (for example, iron oxyhydroxide) on the heat transfer surface of a boiler tube by means of a silica component and the pH adjustor in order to prevent the corrosion of the heat transfer surface. However, when the thickness of each of the silica layer and the iron hydroxide layer formed on the heat transfer surface is insufficient, no anticorrosive action is exerted, so the heat transfer surface may be corroded.

In addition, when the heat transfer surface is covered with the corrosion product, there arises a problem in that the heat transfer property of a boiler deteriorates owing to the low thermal conductivity of the corrosion product. In addition, when the entire heat transfer surface cannot be uniformly covered with the silica layer and the iron hydroxide layer, local corrosion (pitting corrosion) may occur on the heat transfer surface. When the heat transfer surface is locally corroded, a hole penetrating the boiler tube may be opened, so there arises a problem in that water leaks from the hole into the furnace of the boiler.

### SUMMARY OF THE INVENTION

An object of the present invention is to provide a water treating agent capable of preventing the general corrosion and local corrosion of the heat transfer surface of a boiler tube and of providing excellent heat transfer property, and a water treatment method using the water treating agent.

The object of the present invention may be achieved by providing a water treating agent including: water as a main component; a coating film forming agent of which a coating film is formed on a heat transfer surface of a boiler tube; a oxygen scavenger; a scale inhibitor; and a pH adjustor.

With such constitution, a coating film capable of suppressing corrosion is formed of the coating film forming agent on the heat transfer surface of the boiler tube. Dissolved oxygen in boiler feed water is removed by the oxygen scavenger. Furthermore, the scaling of the heat transfer surface of the boiler tube is prevented by the scale inhibitor, and the pH of the boiler feed water is adjusted. Therefore, the general corrosion and local corrosion of the heat transfer surface of the boiler tube can be prevented, and excellent heat transfer property can be obtained.

The coating film forming agent includes at least one kind selected from the group consisting of silica, sodium silicate, potassium silicate, an orthosilicate, and a polysilicate.

With such constitution, a coating film capable of suppressing corrosion is formed of at least one kind or two or more kinds of silica, sodium silicate, potassium silicate, an orthosilicate, and a polysilicate each serving as the coating film forming agent on the heat transfer surface of the boiler tube. Therefore, the general corrosion and local corrosion of the heat transfer surface of the boiler tube can be additionally prevented, and excellent heat transfer property can be obtained.

The oxygen scavenger includes at least one kind selected from the group consisting of vitamin C and a salt thereof, tannin, a saccharide type oxygen scavenger, erythorbic acid and a salt thereof, and sulfite.

Here, for examples vitamin C and a salt thereof are used for the oxygen scavenger because oxygen dissolved into boiler feed water can be removed owing to the strong reducing power of the oxygen scavenger and the oxygen scavenger has no toxicity unlike hydrazine. The boiler feed water from which dissolved oxygen has been removed exhibits a reduced corrosive action on the heat transfer surface of the boiler tube.

With such constitution, dissolved oxygen in the boiler feed water is removed by a oxygen scavenger having no toxicity such as a oxygen scavenger composed of at least one kind or two or more kinds of vitamin C and a salt thereof, tannin, a saccharide type oxygen scavenger, erythorbic acid and a salt thereof, and sulfite. Therefore, the general corrosion and local corrosion of the heat transfer surface of the boiler tube can be additionally prevented, and excellent heat transfer property can be obtained.

The scale inhibitor includes at least one kind selected from the group consisting of citric acid, ethylenediaminetetraacetic acid and a salt thereof, polyacrylic acid and a salt thereof, and polymaleic acid and a salt thereof.

Here, the scale inhibitor is used because it can prevent the adhesion of a scale to the heat transfer surface of the boiler tube (scaling). That is, when citric acid, and ethylenediaminetetraacetic acid and a salt thereof are used for the scale inhibitor, a calcium ion or a magnesium ion in the boiler feed water is chelated by the scale inhibitor, so it cannot adhere as a scale to the heat transfer surface of the boiler tube. In addition, when polyacrylic acid, polymaleic acid, or the like is used for the scale inhibitor, the growth of the crystal nucleus of a scale formed of a calcium ion or a magnesium ion is prevented, so such ion cannot adhere as a scale to the heat transfer surface of the boiler tube.

With such constitution, the scaling of the heat transfer surface of the boiler tube is prevented by the scale inhibitor composed of at least one kind or two or more kinds of citric acid, ethylenediaminetetraacetic acid and a salt thereof, polyacrylic acid and a salt thereof, and polymaleic acid and a salt thereof. As described above, the scaling of the heat transfer surface of the boiler tube is prevented by, for example, ethylenediaminetetraacetic acid and a salt thereof each serving as the scale inhibitor. Therefore, the general corrosion and local corrosion of the heat transfer surface of the boiler tube can be prevented, and additionally excellent heat transfer property can be obtained.

The pH adjustor includes at least one kind selected from the group consisting of hydroxides of alkali metals such as sodium hydroxide and potassium hydroxide.

Here, the pH adjustor is used for adjusting the pH of the boiler feed water to an alkali side so that the corrosion of the heat transfer surface of the boiler tube is prevented.

With such constitution, the pH of the boiler feed water is adjusted by the pH adjustor composed of at least one kind or two or more kinds of hydroxides of alkali metals such as sodium hydroxide and potassium hydroxide. As described above, the pH of the boiler feed water is adjusted by the pH adjustor such as sodium hydroxide. Therefore, the general corrosion and local corrosion of the heat transfer surface of the boiler tube can be prevented, and excellent heat transfer property can be obtained.

In addition, the object of the present invention may be achieved by means of a water treatment method including the steps of: adjusting the concentration of the above-described water treating agent to a predetermined concentration; detecting the concentration of silica dissolved into a water supply tank and a dissolved oxygen amount in the tank; and controlling the amount of the above-described water treating agent to be supplied to the water supply tank.

With such constitution, when a silica concentration or a dissolved oxygen amount in boiler feed water fluctuates, the amount of a water treating agent, which contains a coating film forming agent of which a coating film is formed on the heat transfer surface of a boiler tube, a oxygen scavenger, a scale inhibitor, and a pH adjustor, and the concentration of which is adjusted to a predetermined concentration, to be supplied to the water supply tank can be controlled in correspondence with the fluctuation. As a result, even when a silica concentration or a dissolved oxygen amount in the boiler feed water fluctuates, the general corrosion and local corrosion of the heat transfer surface of the boiler tube can be prevented, and excellent heat transfer property can be obtained by adjusting the concentration of a water treating agent to a predetermined concentration and by controlling the amount of the water treating agent the concentration of which has been adjusted to be supplied to the water supply tank in correspondence with the fluctuation.

### BRIEF DESCRIPTION OF THE DRAWING

FIG. 1 is a schematic view showing the constitution of a steam boiler device according to Example 2 of the present invention.

### DESCRIPTION OF THE PREFERRED EMBODIMENTS

The present invention is realized by a water treating agent constituted by blending water as a main component with a coating film forming agent of which a coating film is formed on the heat transfer surface of a boiler tube, a oxygen scavenger, a scale inhibitor, and a pH adjustor.

At least one kind or two or more kinds of known coating film forming agents such as silica (silicic anhydride), sodium silicate, potassium silicate, an orthosilicate, and a polysilicate are used for the coating film forming agent of the water treating agent. The coating film forming agent is adsorbed to the heat transfer surface of a boiler tube to form a coating film with which the heat transfer surface of the boiler tube is covered. The coating film formed of the coating film forming agent covers the heat transfer surface of the boiler tube to serve as a barrier layer, thereby acting as a protective coating film against corrosion. Therefore, the corrosion of the heat transfer surface of the boiler tube covered with the protective coating film is suppressed.

At least one kind or two or more kinds of known oxygen scavengers such as vitamin C and a salt thereof, tannin, a saccharide type oxygen scavenger, erythorbic acid and a salt thereof, and sulfite are used for the oxygen scavenger to be used together with the coating film forming agent. The oxygen scavenger has no toxicity unlike hydrazine, and can remove oxygen dissolved into boiler feed water. Oxygen dissolved into the boiler feed water serves as an oxidant to exhibit a corrosive action on the heat transfer surface of a boiler tube. Therefore, the removal of oxygen dissolved into the boiler feed water by means of the oxygen scavenger prevents the general corrosion of the heat transfer surface of the boiler tube because an oxidant concentration in the boiler feed water reduces. In addition, the removal of oxygen dissolved into the boiler feed water reduces the nonuniformity of an oxygen concentration on the heat transfer surface of the boiler tube. As a result, an oxygen concentration cell is hardly formed, and the local corrosion of the heat transfer surface of the boiler tube is prevented. Here, detailed description will be given of the prevention of the local corrosion of the heat transfer surface of a boiler tube by means of the water treating agent according to an embodiment of the present invention.

In general, when a coating film capable of preventing corrosion is formed on the heat transfer surface of a boiler tube, a material (such as carbon steel) used for the heat transfer surface of the boiler tube is hardly corroded by boiler feed water. The coating film formed on the heat transfer surface of the boiler tube is a result of, for example, the adsorption of a silica component to the surface of carbon steel or the formation of iron oxyhydroxide on the surface of carbon steel. However, the surface of the heat transfer surface of the boiler tube may have a portion where the formation of a coating film is insufficient owing to a factor inhibiting the formation of a coating film (coating film deficient portion). There are various factors inhibiting the formation of a coating film including: the presence of a chloride ion inhibiting the formation of a coating film in the boiler feed water; the nonuniformity of a surface due to the surface segregation of sulfur (sulfide) or the like in carbon steel; and the nonuniformity of the concentration of a coating film forming agent due to the nonuniform flow rate of the boiler feed water flowing in the boiler tube. When a factor inhibiting the formation of a coating film is present, the surface of the heat transfer surface of the boiler tube has a coating film portion formed of silica or iron oxide (sound coating film portion) and a portion where the formation of a coating film is insufficient (coating film deficient portion). The sound coating film portion and the coating film deficient portion form a local cell, so local corrosion occurs in some cases.

By the way, it is generally known that local corrosion such as gap corrosion or pitting corrosion (which refers to the corrosion of a metal surface, the corrosion not being uniform, and the corrosion occurring locally in a concentrated manner) is apt to occur in an environment where general corrosion (which refers to corrosion occurring nearly uniformly on a metal surface) hardly occurs. A metal surface is not locally corroded because general corrosion occurs nearly uniformly on the metal surface. In contrast, local corrosion is apt to occur in a coating film deficient portion in the case where the corrosion of the metal surface is entirely suppressed by a passive coating film or a protective coating film (a sound coating film is formed to suppress general corrosion). This is because the coating film deficient portion is more likely to be corroded than the sound coating film portion, so the coating film deficient portion is locally corroded in a concentrated manner.

That is, the reason for the foregoing is as described below. A local cell is formed between the coating film deficient portion and the sound coating film portion, the coating film deficient portion serves as the anode electrode of the local cell (the negative electrode of the cell where an oxidation reaction occurs and a metal is dissolved, that is, corroded), and the sound coating film portion serves as the cathode electrode of the local cell (the positive electrode of the cell where a reduction reaction occurs and a metal is not dissolved, that is, not corroded). The local cell has an oxygen concentration cell formed therein so that a cell reaction proceeds. It is generally known that an oxygen concentration cell shows a larger corrosion rate as a ratio between the oxygen amount (concentration) of a sound coating film portion of which a cathode is formed and that of a coating film deficient portion of which an anode is formed becomes larger (a cell electromotive force becomes larger). In other words, the fact means that local corrosion due to the coating film deficient portion can be prevented (suppressed) by reducing the ratio between the oxygen amount (concentration) of the sound coating film portion and that of the coating film deficient portion.

The water treating agent of the present invention prevents local corrosion because the agent reduces the amount (concentration) of oxygen dissolved into boiler feed water by means of a oxygen scavenger so that an oxygen concentration cell is hardly formed even when the coating film formed of the above coating film forming agent on the heat transfer surface of a boiler tube forms a coating film deficient portion owing to a certain reason. That is, a reduction in amount (concentration) of oxygen dissolved into the boiler feed water reduces the absolute amount of the oxygen amount (concentration) of a sound coating film portion. Therefore, a ratio between the oxygen amount (concentration) of the sound coating film portion and that of the coating film deficient portion reduces, so the electromotive force of the oxygen concentration cell reduces and local corrosion can be prevented.

In addition, the water treating agent of the present invention is blended with a scale inhibitor as well as the oxygen scavenger. At least one kind or two or more kinds of known scale inhibitors such as citric acid, ethylenediaminetetraacetic acid and a salt thereof, polyacrylic acid, and polymaleic acid are used for the scale inhibitor. When citric acid, and ethylenediaminetetraacetic acid and a salt thereof (EDTA-Na) are used for the scale inhibitor, a calcium ion or a magnesium ion in boiler feed water is chelated by the scale inhibitor, so a scale hardly adheres to the heat transfer surface of a boiler tube. In addition, when polyacrylic acid and a salt thereof, polymaleic acid and a salt thereof, and the like are used for the scale inhibitor, the growth of the crystal nucleus of a scale formed of a calcium ion or a magnesium ion is prevented, so a scale hardly adheres to the heat transfer surface of the boiler tube. As described above, when a scale hardly adheres to the heat transfer surface of the boiler tube, a boiler can operate while maintaining its excellent heat transfer property.

Furthermore, the water treating agent is blended with a pH adjustor. At least one kind or two or more kinds of known pH adjustors such as hydroxides of alkali metals such as sodium hydroxide and potassium hydroxide are used for the pH adjustor. The pH adjustor adjusts the pH of boiler feed water to an alkali side so that the corrosion of the heat transfer surface of a boiler tube is prevented.

By the way, each of the coating film forming agent, the oxygen scavenger, the scale inhibitor, and the pH adjustor in the present invention can be dissolved as an individual chemical into water before it is supplied. However, in consideration of the labor of loading (injecting) a water treating agent, they are desirably dissolved together into water to prepare a single preparation.

### EXAMPLES

Hereinafter, an example (anyone of Examples 1 to 3) of a water treating agent according to an embodiment of the present invention will be described in detail on the basis of Table 1.

TABLE 1

| | | | | Comparative | |
|---|---|---|---|---|---|
| | Example | | | example | |
| | 1 | 2 | 3 | 1 | 2 |
| Sodium silicate [g] | 1.26 | 5.46 | 9.66 | 0.04 | 21.5 |
| Vitamin C [g] | 2.5 | 5.0 | 7.5 | 0.0 | 0.0 |
| EDTA-2Na [g] | 0.4 | 0.4 | 0.4 | 0.4 | 0.4 |
| Sodium hydroxide | 4.0 | 4.0 | 4.0 | 4.0 | 4.0 |
| [g] | | | | | |
| Presence or absence | Absent | Absent | Absent | Absent | Absent |
| of general corrosion | | | | | |
| Presence or absence | Slightly | Absent | Absent | Present | Absent |
| of local corrosion | present | | | | |
| Maximum depth of | 80 | 33 | 2 | 130 | 2 |
| pitting corrosion | | | | | |
| [μm] | | | | | |
| Presence or absence | Absent | Absent | Absent | Absent | Present |
| of adhesion of scale | | | | | |
| Ca solubility of | ≧10 | ≧10 | ≧10 | ≧10 | 8.2 |
| boiler water | | | | | |
| [mg/liter] | | | | | |

### (1) Example 1

The water treating agent of Example 1 shown in Table 1 is obtained by blending pure water with a coating film forming agent, a oxygen scavenger, a scale inhibitor, and a pH adjustor each in a predetermined amount per 100 g in total of the water treating agent. That is, the water treating agent of Example 1 is obtained by blending 1.26 g of sodium silicate (Wako Pure Chemical Industries, Ltd., guaranteed reagent) as a coating film forming agent, 2.5 g of vitamin C (L-ascorbic acid) (Wako Pure Chemical Industries, Ltd., guaranteed reagent) as a oxygen scavenger, 0.4 g of EDTA-2Na (Wako Pure Chemical Industries, Ltd., guaranteed reagent) as a scale inhibitor, and 4.0 g of sodium hydroxide (Wako Pure Chemical Industries, Ltd., guaranteed reagent) as a pH adjustor. 500 mg of the water treating agent were loaded into per 1 liter of softened water. Here, softened water of Osaka City that has been artificially adjusted is used as softened water to serve as boiler feed water. The adjusted softened water has properties of water including a pH of 7.5, an electric conductivity of 25 mS/m, an M alkaline strength of 20 mg/liter-CaCO₃, and a hardness of 1 mg/liter-CaCO₃. The softened water of Osaka City that has been artificially adjusted is used for softened water to be used for each of examples and comparative examples of the water treating agent, and description about the softened water is omitted hereinafter.

### (2) Example 2

The water treating agent of Example 2 is obtained by blending pure water with a coating film forming agent, a oxygen scavenger, a scale inhibitor, and a pH adjustor each in a predetermined amount per 100 g in total of the water treating agent, in the same manner as in the water treating agent of Example 1. That is, the water treating agent of Example 2 is obtained by blending 5.46 g of sodium silicate (Wako Pure Chemical Industries, Ltd., guaranteed reagent) as a coating film forming agent, 5.0 g of vitamin C (L-ascorbic acid) (Wako Pure Chemical Industries, Ltd., guaranteed reagent) as a oxygen scavenger, 0.4 g of EDTA-2Na (Wako Pure Chemical Industries, Ltd., guaranteed reagent) as a scale inhibitor, and 4.0 g of sodium hydroxide (Wako Pure Chemical Industries, Ltd., guaranteed reagent) as a pH adjustor. 500 mg of the water treating agent were loaded into per 1 liter of softened water.

### (3) Example 3

The water treating agent of Example 3 is obtained by blending pure water with a coating film forming agent, a oxygen scavenger, a scale inhibitor, and a pH adjustor each in a predetermined amount per 100 g in total of the water treating agent, in the same manner as in the water treating agent of Example 1. That is, the water treating agent of Example 3 is obtained by blending 9.66 g of sodium silicate as a coating film forming agent, 7.5 g of vitamin C (L-ascorbic acid) (Wako Pure Chemical Industries, Ltd., guaranteed reagent) as a oxygen scavenger, 0.4 g of EDTA-2Na (Wako Pure Chemical Industries, Ltd., guaranteed reagent) as a scale inhibitor, and 4.0 g of sodium hydroxide (Wako Pure Chemical Industries, Ltd., guaranteed reagent) as a pH adjustor. 500 mg of the water treating agent were loaded into per 1 liter of softened water.

### COMPARATIVE EXAMPLES

### (1) Comparative Example 1

The water treating agent of Comparative Example 1 is obtained by blending pure water with a coating film forming agent, a scale inhibitor, and a pH adjustor each in a predetermined amount per 100 g in total of the water treating agent. That is, the water treating agent of Comparative Example 1 is obtained by blending 0.04 g of sodium silicate (Wako Pure Chemical Industries, Ltd., guaranteed reagent) as a coating film forming agent, 0.4 g of EDTA-2Na (Wako Pure Chemical Industries, Ltd., guaranteed reagent) as a scale inhibitor, and 4.0 g of sodium hydroxide (Wako Pure Chemical Industries, Ltd., guaranteed reagent) as a pH adjustor. 500 mg of the water treating agent were loaded into per 1 liter of softened water.

### (2) Comparative Example 2

The water treating agent of Comparative Example 2 is obtained by blending pure water with a coating film forming agent, a scale inhibitor, and a pH adjustor each in a predetermined amount per 100 g in total of the water treating agent, in the same manner as in the water treating agent of Comparative Example 1. That is, the water treating agent of Comparative Example 2 is obtained by blending 21.5 g of sodium silicate (Wako Pure Chemical Industries, Ltd., guaranteed reagent) as a coating film forming agent, 0.4 g of EDTA-2Na (Wako Pure Chemical Industries, Ltd., guaranteed reagent) as a scale inhibitor, and 4.0 g of sodium hydroxide (Wako Pure Chemical Industries, Ltd., guaranteed reagent) as a pH adjustor. 500 mg of the water treating agent were loaded into per 1 liter of softened water.

[Evaluation]

(1) Experimental Conditions

Boiler feed water added with a predetermined amount of each of the water treating agents shown in Examples 1 to 3 and Comparative Examples 1 and 2 was used to evaluate the heat transfer surface of a boiler tube for scale adhesion property and corrosion. The evaluation for scale adhesion property and corrosion was performed by means of an experimental once-through boiler having an amount of evaporation of 1.35 kg/hr. Softened water added with a predetermined amount of each of the water treating agents shown in Examples 1 to 3 and Comparative Examples 1 and 2 intended for boiler feed water was supplied to the experimental once-through boiler, and the boiler was operated in such a manner that the blow rate of the boiler feed water would be 10% while steam having a pressure of 0.3 MPa was continuously generated. The experimental once-through boiler was operated continuously for 48 hours in such a manner that the evaluation of the heat transfer surface of the boiler tube for scale adhesion property and corrosion would be as close as possible to the evaluation of an actual device. The heat transfer surface of the boiler tube was evaluated for scale adhesion property by: sampling boiler water (referring to water in the boiler tube which had received heating) 24 hours after the initiation of the operation of the boiler; measuring the Ca concentration in the boiler water; evaluating the boiler water for Ca solubility; extracting a boiler tube for evaluation from the experimental once-through boiler after the completion of the operation for 48 hours; and observing the heat transfer surface of the boiler tube. In addition, the heat transfer surface of the boiler tube was evaluated for corrosion by observing the heat transfer surface of the boiler tube for evaluation.

(2) Evaluation on Scale Adhesion Property

The heat transfer surface of a boiler tube is evaluated for scale adhesion property through the following procedure.

At first, boiler water is sampled 24 hours after the initiation of the operation of the boiler. The Ca concentration of the sampled boiler water is measured by means of an ICP light emission analyzer. The boiler water is evaluated for Ca solubility on the basis of the measured Ca concentration. Then, the heat transfer surface of the boiler tube is evaluated for scale adhesion property. Here, the evaluation for scale adhesion property based on the evaluation for Ca solubility is performed by paying attention to the fact that the precipitation of Ca as a scale on the heat transfer surface of the boiler tube reduces the Ca concentration, that is, Ca solubility of the boiler water. To be specific, if the experimental once-through boiler is operated at a blow rate of the boiler water containing Ca at a concentration of 1.0 mg/liter-CaCO₃ and Ca does not precipitate as a scale on the heat transfer surface of the boiler tube, the Ca solubility of the boiler water does not reduce, and the Ca concentration is detected while maintaining its value of about 10 mg/liter. On the other hand, if Ca precipitates as a scale on the heat transfer surface of the boiler tube, the Ca solubility of the boiler water reduces, and a Ca concentration lower than 10 mg/liter is detected.

Next, the operation of the experimental once-through boiler is stopped 48 hours after the initiation of the operation of the boiler. A boiler tube is extracted from the stopped boiler. Whether Ca adheres as a scale to the heat transfer surface of the boiler tube is observed with the eyes and a loupe, followed by evaluation for scale adhesion property. The evaluation for scale adhesion property can also be performed on the basis of the thickness of a scale adhering to the heat transfer surface of the boiler tube, the thickness being measured by means of a thickness meter.

Thus, Table 1 shows the Ca solubility of the boiler feed water added with a predetermined amount of each of the water treating agents shown in Examples 1 to 3 and Comparative Examples 1 and 2 as a Ca concentration 24 hours after the initiation of the operation of the boiler.

According to the results shown in Table 1, the boiler feed water added with a predetermined amount of each of the water treating agents shown in Examples 1 to 3 and Comparative Example 1 had a Ca solubility of 10 mg/liter or more. On the other hand, the boiler feed water added with a predetermined amount of the water treating agent shown in Comparative Example 2 had a Ca solubility of 10 mg/liter or less. The Ca solubility in the water treating agent of Comparative Example 2 was small because a thick layer of a silica component in sodium silicate bound to Ca adhered to the heat transfer surface of the boiler tube owing to a large sodium silicate concentration in the boiler feed water.

(3) Evaluation for Corrosion

The heat transfer surface of a boiler tube was evaluated for corrosion through the following procedure. At first, the operation of the boiler is stopped 48 hours after the initiation of the operation. A boiler tube is extracted from the stopped boiler. A scale is removed from the surface of the tube through water washing or acid cleaning. Next, the surface of the boiler tube from which a scale has been removed is visually observed with the eyes, a loupe, or the like for investigation into the presence or absence of general corrosion. Finally, whether local corrosion such as pitting corrosion (also referred to as pitting) occurs on the surface of the boiler tube from which a scale has been removed is visually observed with the eyes, a loupe, or the like. The depth of a site where pitting corrosion occurs is measured with an optical displacement gauge so that the maximum depth of pitting corrosion is determined.

Table 1 shows the presence or absence of general corrosion, the presence or absence of local corrosion, and the maximum depth of pitting corrosion in the heat transfer surface of a boiler tube for boiler feed water added with a predetermined amount of each of the water treating agents shown in Examples 1 to 3 and Comparative Examples 1 and 2.

According to the results shown in Table 1, the general corrosion and local corrosion of the heat transfer surface of a boiler tube were prevented in case of the boiler feed water added with a predetermined amount of each of the water treating agents shown in Examples 1 to 3 and Comparative Example 2. On the other hand, the general corrosion of the heat transfer surface of a boiler tube was prevented, but the local corrosion of the heat transfer surface was not prevented in case of the boiler feed water added with a predetermined amount of the water treating agent shown in Comparative Example 1.

As can be seen from the foregoing, according to any one of the water treating agents according to Examples 1 to 3, a coating film capable of suppressing corrosion is formed of the coating film forming agent on the heat transfer surface of the boiler tube. Dissolved oxygen in boiler feed water is removed by the oxygen scavenger. Furthermore, the scaling of the heat transfer surface of the boiler tube is prevented by the scale inhibitor, and the pH of the boiler feed water is adjusted. Therefore, the general corrosion and local corrosion of the heat transfer surface of the boiler tube can be prevented, and excellent heat transfer property can be obtained.

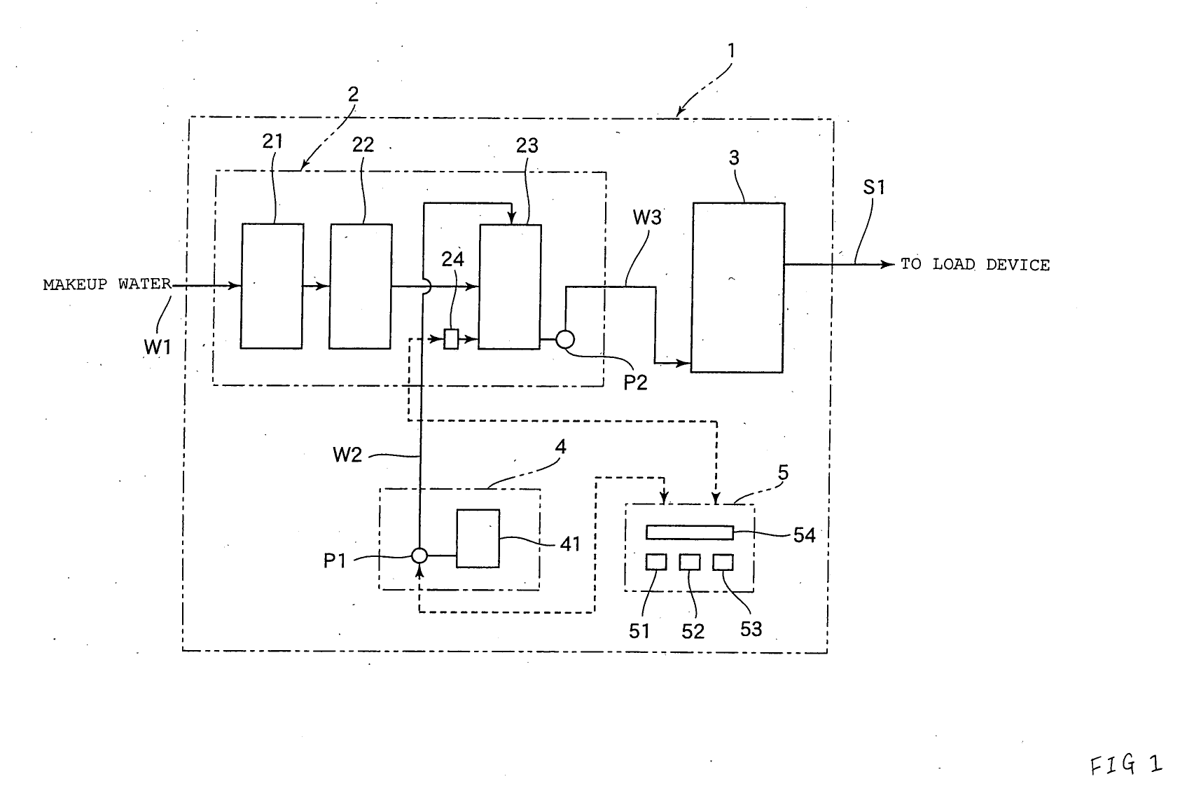

Next, an example of a water treatment method using the water treating agent of the present invention for a steam boiler device will be described with reference to FIG. 1. FIG. 1 shows the schematic constitution of a steam boiler device.

In FIG. 1, a steam boiler device 1 is constituted by a water supply device portion 2, a steam boiler 3, a water treating agent supply portion 4, and a control portion 5.

The water supply device portion 2 is constituted by various pretreatment devices supplying boiler feed water to the steam boiler 3, and is equipped with a water softener 21, a deaeration device 22, and a water supply tank 23. The water softener 21 is a device for subjecting makeup water such as tap water or industrial water supplied from the outside via a makeup water supplying path W1 to a softening treatment (softening). The makeup water is subjected to a softening treatment (softened) for removing a calcium ion or a magnesium ion in the makeup water. Here, the calcium ion or the magnesium ion is removed for preventing such ion from adhering as a scale to the heat transfer surface of a boiler tube to reduce heat transfer property. The makeup water (soft water) softened by the water softener 21 is deaerated by the deaeration device 22.

The deaeration device 22 is a device mainly intended for removing dissolved oxygen in soft water in advance because the presence of dissolved oxygen in soft, water makes the heat transfer surface of a boiler tube prone to corrode with the oxygen. For example, a device for continuously removing oxygen by means of a gas separable membrane or through heating, or a batch type device utilizing reduced pressure or ultrasonic wave is used for the deaeration device 22. Of those, a device using a gas separable membrane that is a membrane through which a gas passes and no liquid passes is a preferable device because the device can be easily handled, can be continuously operated stably, and is inexpensive. That is, a device using a gas separable membrane can deaerate soft water by: causing water subjected to a softening treatment (soft water) to flow into the gas separable membrane; and establishing a vacuum state outside the membrane so that a gas in the soft water passes through the membrane to be evacuated to the outside of the membrane.

The soft water from which dissolved oxygen has been removed by the deaeration device 22 is reserved in the water supply tank 23. The water supply tank 23 reserves boiler feed water to be supplied to the steam boiler 3, and is equipped with a detection portion 24 for measuring and detecting a silica concentration and a dissolved oxygen amount in the boiler feed water. The soft water deaerated by the deaeration device 22 and condensed water that has received heat exchange with steam generated by the steam boiler 3 in a load device (not shown) are supplied to the water supply tank 23 via a condensed water collecting path (not shown). In addition, a water treating agent reserved in a water treating agent tank 41 to be described later is supplied by a chemical supplying pump P1 via a water treating agent supplying path W2 to the water supply tank 23 for treating the boiler feed water with a chemical. The water treating agent is a water treating agent described in the above embodiment of the present invention, and is obtained by blending water as a main component with a coating film forming agent of which a coating film is formed on the heat transfer surface of a boiler tube, a oxygen scavenger, a scale inhibitor, and a pH adjustor. Therefore, supplying the water treating agent to the boiler feed water can prevent the corrosion of the heat transfer surface of the boiler tube and the adhesion of a scale to the heat transfer surface. The boiler feed water is supplied by a water supplying pump P2 from the water supply tank 23 to the steam boiler 3 via a water supplying path W3.

Here, the silica concentration detected by the detection portion 24 is the concentration of silica (silicon dioxide), and is measured and detected in accordance with molybdenum yellow absorption photometry described in JIS K 0101. In addition, a dissolved oxygen amount is measured and detected in accordance with the industrial water testing method described in JIS K 0101.

The steam boiler 3 to which the boiler feed water has been supplied generates steam, and the steam is supplied to various load devices (not shown) via a steam line S1.

The steam boiler 3 heats the boiler feed water to generate steam, and is in a high-temperature, high-pressure environment. In particular, a boiler tube (not shown) is in a severe environment because the outer surface side of the tube directly receives radiation heat from a heating source and high-temperature, high-pressure boiler feed water or steam flows on the inner surface side of the tube (the heat transfer surface of the boiler tube). When the boiler feed water has poor water quality, the heat transfer surface of the boiler tube is corroded, or a scale adheres to the heat transfer surface. Accordingly, the steam boiler 3 may be unable to perform a stable operation continuously for a long time period. Therefore, the management of the properties of water of the boiler feed water is an important item, and such water treatment method for boiler feed water as shown in this example has been demanded.

The water treatment method of this example is a method involving supplying the water treating agent the concentration of which has been adjusted to a predetermined concentration in advance and which is reserved in the water treating agent tank 41 to the water supply tank 23 in correspondence with a fluctuation in concentration of silica or amount of oxygen dissolved into the boiler feed water reserved in the water supply tank 23 if such fluctuation occurs. In this case, the amount of the water treating agent to be supplied to the water supply tank 23 is controlled in correspondence with a fluctuation in silica concentration or dissolved oxygen amount. The amount of the water treating agent to be supplied is controlled by controlling the ejection amount of the chemical supplying pump P1 of the water treating agent, supply portion 4 by means of the control portion 5 to be described later.

The water treating agent supply portion 4 is constituted by the above-described water treating agent tank 41 reserving the water treating agent and the chemical supplying pump P1 for supplying the water treating agent from the water treating agent tank 41 to the water supply tank 23. The water treating agent tank 41 reserves the water treating agent the concentration of which has been adjusted to a predetermined concentration in advance.

A fluctuation in silica concentration or dissolved oxygen amount in the boiler feed water is judged by the control portion 5 on the basis of the silica concentration or dissolved oxygen amount in the boiler feed water detected by the detection portion 24 possessed by the water supply tank 23.

As shown in FIG. 1, the control portion 5 is electrically connected to each of the devices constituting the water supply device portion 2 and the water treating agent supply portion 4. To be specific, the control portion 5 is electrically connected to the detection portion 24 possessed by the water supply tank 23 and the chemical supplying pump P1.

The control portion 5 is constituted as a logical circuit mainly composed of a microcomputer, and includes: a central processing unit (CPU) 51; an RAM 52 for temporarily recording data; an ROM 53 on which a processing program is recorded; and an input/output port 54 for inputting or outputting various signals. As described above, information concerning a silica concentration or a dissolved oxygen amount is inputted to the control portion 5 from the detection portion 24, and the control portion outputs a signal for controlling the ejection amount of the chemical supplying pump P1 on the basis of the input, to thereby control the ejection amount of the chemical supplying pump P1.

An increase in amount of the water treating agent to be supplied to the water supply tank 23 makes a scale apt to adhere to the heat transfer surface of the boiler tube, so heat transfer property deteriorates. The control of the ejection amount of the chemical supplying pump P1 is intended for preventing the deterioration. On the other hand, a reduction in amount of the water treating agent to be supplied to the water supply tank 23 reduces the thickness of a silica layer or of an iron hydroxide layer to be formed on the heat transfer surface of the boiler tube, so the heat transfer surface of the boiler tube may undergo general corrosion. The control is intended also for preventing the general corrosion. In addition, when the distribution of the thickness of the silica layer or of the iron hydroxide layer to be formed on the heat transfer surface of the boiler tube becomes nonuniform, the heat transfer surface of the boiler tube is apt to undergo local corrosion. The control is intended also for preventing the local corrosion.

As described above, according to the water treatment method of this example, when a silica concentration or a dissolved oxygen amount in boiler feed water fluctuates, the general corrosion and local corrosion of the heat transfer surface of a boiler tube can be prevented, and excellent heat transfer property can be obtained by controlling the amount of a water treating agent, which is obtained by blending a coating film forming agent of which a coating film is formed on the heat transfer surface of the boiler tube, a oxygen scavenger, a scale inhibitor, and a pH adjustor, and the concentration of which is adjusted to a predetermined concentration, to be supplied from a water treating agent tank to a water supply tank in correspondence with the fluctuation.

What is claimed is:

1. A water treating agent comprising:
water as a main component;
a coating film forming agent of which a coating film is formed on a heat transfer surface of a boiler tube;
a oxygen scavenger;
a scale inhibitor; and
a pH adjustor.

2. A water treating agent according to claim 1, wherein the coating film forming agent comprises at least one kind selected from the group consisting of silica, sodium silicate, potassium silicate, an orthosilicate, and a polysilicate.

3. A water treating agent according to claim 1 or 2, wherein the oxygen scavenger comprises at least one kind selected from the group consisting of vitamin C and a salt thereof, tannin, a saccharide type oxygen scavenger, erythorbic acid and a salt thereof, and sulfite.

4. A water treating agent according to any one of claims 1 to 3, wherein the scale inhibitor comprises at least one kind selected from the group consisting of citric acid, ethylenediaminetetraacetic acid and a salt thereof, polyacrylic acid and a salt thereof, and polymaleic acid and a salt thereof.

5. A water treating agent according to any one of claims 1 to 4, wherein the pH adjustor comprises at least one kind selected from the group consisting of hydroxides of alkali metals such as sodium hydroxide and potassium hydroxide.

6. A water treatment method comprising the steps of:
adjusting a concentration of the water treating agent according to any one of claims 1 to 5 to a predetermined concentration;
detecting a concentration of silica dissolved into a water supply tank and a dissolved oxygen amount in the tank; and
controlling an amount of the water treating agent to be supplied to the water supply tank.
